(19) United States
(12) Patent Application Publication
(10) Pub. No.: US 2002/0104509 A1
(43) Pub. Date: Aug. 8, 2002

(54) Variable valve timing of an engine compression brake

(76) Inventors: Sameer Bhargava, Canton, MI (US); Steven J. Funke, Princeville, IL (US); Scott A. Leman, Eureka, IL (US); Matthew G. Mickiewicz, Clayton, NC (US); Joshua C. Ruedin, Peoria, IL (US)

Correspondence Address: Larry G. Cain, Caterpillar Inc., Intellectual Property Department, 100 N.E. Adams Street, AB6490, Peoria, IL, 61629-6490, US

(21) Appl. No.: 09/776,986

(22) Filed: Feb. 5, 2001

(51) Int. Cl. F02D 13/04; F01L 9/04

(52) U.S. Cl. 123/322; 123/90.11

(57) ABSTRACT

A method and an apparatus for controlling combustion engine compression braking has the variable timing of the opening of at least one exhaust valve by an electronic control module within each one of the engine cylinders and within a time range of 15°-150° before the top-dead-center position of each cylinder piston during each compression stroke such that variable compression braking power levels, and attendant noise levels, can be obtained as required or desired dependent upon various road, vehicle, and vehicle location parameters. The system and method facilitate a wide range of braking power levels or values, the braking power is smoothly modulated as a result of all of the designated exhaust valves of the cylinders being activated, and the braking power levels can also be generated as a function of engine speed.

### TECHNICAL FIELD

The present invention relates generally to engine compression release brakes, and more particularly to an apparatus and a method of operating an engine compression release brake so as to achieve various optimum levels of engine braking or braking power while simultaneously minimizing noise levels.

### BACKGROUND ART

Vehicle engine compression brakes are conventionally used to assist and supplement wheel brakes when it is desired to slow heavy vehicles, such as, a tractor-trailer or straight trucks. Engine compression brakes are desirable because they help alleviate overheating of the wheel brakes. Engine compression brakes effectively convert an internal combustion engine from a power generating unit to a power consuming air compressor. In engine compression braking systems, it is known that the later the exhaust valve is opened during the compression stroke of the engine cycle, that is, as the piston is disposed closer to the top-dead-center (TDC) position, the more retarding horsepower or braking will be generated or produced. Conversely, the sooner or earlier the exhaust valve is opened during the compression stroke of the engine cycle, that is, as the piston is disposed closer to the bottom-dead-center (BDC) position, the less retarding horsepower or braking will be generated or produced. When using engine compression braking systems it is also known that the noise levels generated or produced by such engine braking systems vary drastically depending upon the timing of the exhaust valve opening.

When the exhaust valve is opened at an earlier time in the engine cycle, less retarding horsepower or braking, less energy is released due to a smaller pressure differential existing or created across the exhaust valve, and consequently, less noise will be produced or generated. Similarly, when the exhaust valve is opened at a later time in the engine cycle, more retarding horsepower or braking, more energy is released due to a greater pressure differential existing or created across the exhaust valve, and consequently, more noise will be produced or generated. Conventional engine compression braking systems are often characterized by a high level of noise and a lack of smooth operation or a smooth modulation of the braking power.

For example, the conventional Jake Brake type engine compression braking system has a fixed cam operated or cam controlled timing system that is arranged to activate cylinders in pairs in order to achieve an engine braking modes. Accordingly, only three distinct levels of engine braking are available in connection with a six-cylinder engine, whereby the braking modes are not smoothly modulated, but to the contrary, the braking levels or modes are in effect stepped as each successive pair of cylinder exhaust valves are activated. In addition, a substantially large amount of noise is normally generated due to the predetermined setting or control of the timing of the opening of the exhaust valves to occur close to the top-dead-center positions.

While it is theoretically possible to predeterminedly set or control the timing of the opening of one or two of the sets of exhaust valves to occur at earlier times in the engine compression stroke, that is, closer to the bottom-dead-center (BDC) position rather than close to the top-dead-center (TDC) position in order to achieve lower generated noise levels, it is to be remembered that such lower generated noise levels are characteristic of lower braking power levels. Accordingly, since this timing system is fixed as a result of being cam-operated or cam-controlled, such timing cannot therefore be subsequently altered as may be desired in order, for example, to achieve higher braking levels as may be desired or required under particular circumstances road conditions, vehicle characteristics, or the like. Therefore, such fixed, compression braking systems, which may exhibit varying degrees or levels of braking power between sets of cylinders, is not desirable or practical.

The present invention is directed to overcome one or more of the problems as set forth above.

### DISCLOSURE OF THE INVENTION

In one aspect of the invention a method of achieving a wide range of compression braking power levels has the steps of providing at least one exhaust valve within each one of a plurality of cylinders of a combustion engine, wherein each one of the plurality of cylinders has a piston respectively disposed therein, connecting an electronic control module to each one of the exhaust valves disposed within the plurality of engine cylinders such that the electronic control module can respectively activate each one of the exhaust valves disposed within the plurality of engine cylinders, and programming the electronic control module so as to respectively activate each one of the at least one exhaust valve disposed within the plurality of engine cylinders at a predetermined time during a compression stroke of each one of the pistons respectively disposed within the plurality of cylinders wherein the time has a time which is within the range of 15°-150° before the top-dead-center position of the compression stroke so as to enable the engine to generate variable compression braking power levels.

In another aspect of the invention a compression braking power system within a combustion engine for achieving a wide range of compression braking power levels has at least one exhaust valve disposed within each one of a plurality of cylinders of a combustion engine, wherein each one of the plurality of cylinders has a piston respectively disposed therein, and an electronic control module connected to each one of the exhaust valves disposed within the plurality of engine cylinders such that the electronic control module can respectively activate each one of the at least one exhaust valve disposed within each one of the plurality of engine cylinders at a predetermined time during a compression stroke of each one of the pistons respectively disposed within the plurality of cylinders wherein the time has a time which is within the range of 15°-150° before the top-dead-center position of the compression stroke so as to enable the engine to generate variable compression braking power levels.

### BRIEF DESCRIPTION OF THE DRAWINGS

FIG. 1 is a schematic view of a control system for an engine compression braking system; and

FIG. 2 is a graph showing the wide range of braking power, as a function of engine speed.

### BEST MODE FOR CARRYING OUT THE INVENTION

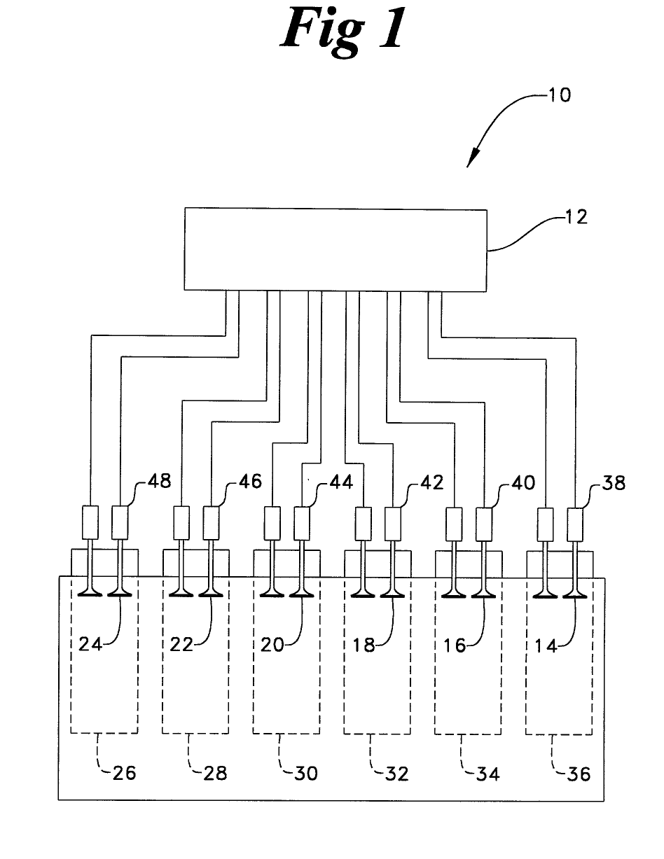

Referring now to FIG. 1, a control system for a six-cylinder engine is schematically disclosed and is generally indicated by the reference character 10. The control system or compression brake system 10 is seen to has of an electronic control module (ECM) 12. The electronic control module 12 is operatively connected to each one of a plurality of exhaust valves 14-24, which are respectively disposed within each one of the engine cylinders 26-36. The electronic control module 12 can control the timing of the opening of each one of the exhaust valves 14-24 through a mechanisms, such as, a well known plurality of solenoid-drives 38-48. While the use of an electronic control module to control the opening of an exhaust valve within an engine is known, and therefore will not be discussed in detail herein, what is submitted to be new and novel is the use of an electronic control module to control the timing of the opening of all of the exhaust valves in varied modes so as to achieve a relatively wide range of braking power as a function of engine speed by varying the opening of the exhaust valves of the engine cylinders at different predetermined times of the compression stroke of each piston within each cylinder such that a smooth modulation of braking power can be achieved and the braking power levels can be varied so as to vary the resulting noise levels as may be desired or required under various road, vehicle, and vehicle location parameters or conditions.

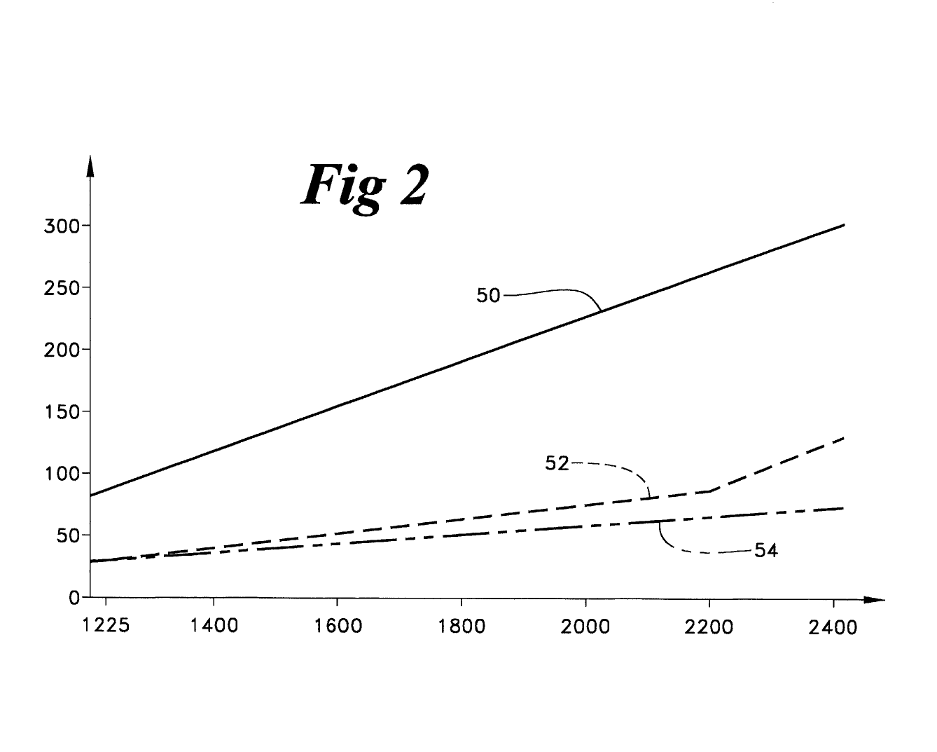

With reference to FIG. 2, a graph illustrates the relatively wide braking range which is obtainable as a result of the braking power, the y axis being varied as a function of engine speed, the x axis. The upper graphical plot or line 50 represents the braking power that can be achieved when each one of the exhaust valves 14-24 is controlled by the electronic control module 12. Each one of the exhaust valves 14-24 is opened at a predeterminedly latest time during the compression stroke of its associated piston within its associated cylinder 26-36. And more particularly, wherein such predeterminedly latest time is fifteen degrees (15°) before the top dead center (TDC) position. This graphical plot or line 50 thus represents the maximum braking power to be achieved. Conversely, the lower graphical plot or line 52 represents the braking power that can be achieved when each one of the exhaust valves 14-24 is controlled by the electronic control module 12. Each one of the exhaust valves 14-24 is opened at a predeterminedly earliest time during the compression stroke of its associated piston within its associated cylinder 26-36. And more particularly, wherein such predeterminedly earliest time is one hundred fifty degrees (150° ) before the top-dead-center (TDC) position. This graphical plot or line 52 thus represents the minimum braking power to be achieved. The lowest graphical plot or line 54 represents the natural frictional braking of the engine when power is not transmitted by the engine.

In order to achieve the above stated valve actuation timings, in practice, the electronic control signal precedes the valve opening by up to 15°

### INDUSTRIAL APPLICABILITY

It can thus be appreciated, when it is recalled from the foregoing that greater braking power and greater noise levels are produced or generated when compression engine braking is achieved at timing positions which are closer to top-dead-center (TDC) positions as opposed to being closer to bottom-dead-center (BDC) positions. When it is desired or required to achieve maximum braking power, such as, in an emergency situation requiring immediate stoppage or slowing of the vehicle, even though such maximum braking power will produce a substantially large amount of noise, the electronic control module 12 can be predeterminedly programmed so as to activate each one of the exhaust valves 14-24 of the engine cylinders 26-36 such that each one of the exhaust valves 14-24 will open at angular positions which correspond to fifteen degrees (15°) before the top-dead-center (TDC) position. Whereas, when it is desired or required to achieve only minimum braking power, with its attendant minimum amount of generated noise, such as, when braking of the vehicle is to occur within city limits or residential neighborhoods, the electronic control module 12 can be predeterminedly programmed so as to activate each one of the exhaust valves 14-24 of the engine cylinders 26-36 such that each one of the exhaust valves 14-24 will open at angular positions which correspond to one hundred fifty degrees (150°) before the top-dead-center (TDC) position.

In order to achieve braking levels which are intermediate the maximum and minimum braking levels which are intermediate the maximum and minimum braking levels denoted by the graphical plots or curves 50 and 52 moderate braking levels with a moderate amount of generated noise the electronic control module 12 can be predeterminedly programmed. The predeterminedly program activates each one of the exhaust valves 14-24 of the engine cylinders 26-36 such that each one of the exhaust valves 14-24 will open at angular positions which are intermediate the angular positions corresponding to fifteen degrees (15°) and one hundred fifty degrees (150°) before the top-dead-center (TDC) position. Consequently, the mode of operation or control of the electronic control module 12, and the resulting operation or control of the exhaust valves 14-24 of the engine cylinders 26-36, is such that trade-offs between achieved braking power and generated noise can be readily, simply, and quickly obtained. Accordingly, smooth modulated braking power can also always be achieved, controlled, and altered by predeterminedly adjusting the operation or control of the electronic control module 12.

The electronic control module 12 can also be predeterminedly controlled so as to activate the exhaust valves 14-24 of the engine cylinders 26-36 as functions of engine speed. For example, the electronic control module 12 can be controlled such that the exhaust valves 14-24 will be opened at different times with respect to the top-dead-center (TDC) positions of the cylinder pistons so as to achieve different levels of braking power as a function of engine speed. In other words, the electronic control module 12 can be predeterminedly programmed so as to achieve various braking levels anywhere within the braking range graph or region delimited by the maximum braking power level plot 50, the minimum braking power level plot 52, an engine speed of 1225 RPM, and an engine speed of 2400 RPM, although higher or lower engine speed limitations are of course possible. For example, the electronic control module 12 can be programmed such that when the engine speed reaches 2000 RPM, the braking power is pre-set, controlled, or limited to be 150 hp even though at such engine speed, a maximum braking power level of approximately 200 hp is able to be achieved. Similarly, other levels of braking power can be preprogrammed into the system such that various braking power levels are achieved as functions of engine speed.

Thus, it may be seen that with the control system of the present invention, at least one exhaust valve within each one of the cylinders of the engine can be controlled so as to achieve smoothly modulated compression braking of the engine, the timing of such engine exhaust valves can be variably controlled so as to achieve maximum, minimum, and intermediate braking power levels with attendant noise generation levels as may be desired or required, and the timing of such engine exhaust valves can be variably controlled as functions of engine speed.

Other aspects objects and advantages of this invention cam be obtained from a study of the drawings, the disclosure and the appended claims in light of the above teachings.

1. A method of achieving a wide range of compression braking power levels within a combustion engine, comprising the steps of:
providing at least one exhaust valve within each one of a plurality of cylinders of a combustion engine, wherein each one of said plurality of cylinders has a piston respectively disposed therein;
connecting an electronic control module to each one of said at least one exhaust valve disposed within each one of said plurality of engine cylinders such that said electronic control module can respectively activate said each one of said at least one exhaust valve disposed within said each one of said plurality of engine cylinders; and
programming said electronic control module so as to respectively activate said each one of said at least one exhaust valve disposed within said each one of said plurality of engine cylinders at a predetermined time during a compression stroke of each one of said pistons respectively disposed within said plurality of cylinders wherein said time includes a time which is within the range of 15°-150° before the top-dead-center position of said compression stroke so as to enable said engine to generate variable compression braking power levels.

2. The method as set forth in claim 1, wherein:
said electronic control module is programmed so as to respectively activate said each one of said at least one exhaust valve disposed within said each one of said plurality of engine cylinders at a predetermined latest time during said compression stroke of each one of said pistons respectively disposed within said plurality of cylinders wherein said latest time includes said time of 15° before said top-dead-center position of said compression stroke so as to enable said engine to generate a maximum compression braking power level.

3. The method as set forth in claim 1, wherein:
said electronic control module is programmed so as to respectively activate said each one of said at least one exhaust valve disposed within said each one of said plurality of engine cylinders at a predetermined earliest time during said compression stroke of each one of said pistons respectively disposed within said plurality of cylinders wherein said earliest time includes said time of 150° before said top-dead-center position of said compression stroke so as to enable said engine to generate a minimum compression braking power level.

4. The method as set forth in claim 1, wherein:
said electronic control module is programmed so as to respectively activate said each one of said at least one exhaust valve disposed within said each one of said plurality of engine cylinders at a predetermined earliest time during said compression stroke of each one of said pistons respectively disposed within said plurality of cylinders wherein said earliest time includes said time of 150° before said top-dead-center position of said compression stroke so as to enable said engine to generate a minimum compression braking power level and a minimum amount of noise.

5. The method as set forth in claim 1, wherein:
said electronic control module is programmed so as to respectively activate said each one of said at least one exhaust valve disposed within said each one of said plurality of engine cylinders at a predetermined time during said compression stroke of each one of said pistons respectively disposed within said plurality of cylinders wherein said predetermined time includes a time which is an intermediate time between said 15°-150° before said top-dead-center position of said compression stroke so as to enable said engine to generate an intermediate amount of compression braking power and said intermediate amount of noise.

6. The method as set forth in claim 1, wherein:
said electronic control module is programmed so as to respectively activate said each one of said at least one exhaust valve disposed within said each one of said plurality of engine cylinders at a predetermined time during said compression stroke of each one of said pistons respectively disposed within said plurality of cylinders wherein said predetermined time includes a time which is intermediate said 15° and 150° time range limitations before said top-dead-center position of said compression stroke so as to enable said engine to generate an intermediate amount of compression braking power and an intermediate amount of noise.

7. The method as set forth in claim 1, wherein:
said electronic control module is programmed so as to respectively activate said each one of said at least one exhaust valve disposed within said each one of said plurality of engine cylinders at a predetermined time during said compression stroke of each one of said pistons respectively disposed within said plurality of cylinders wherein said predetermined time includes a time which is within said 15°-150° range of times before said top-dead-center position of said compression stroke and wherein said predetermined time is chosen as a function of engine speed so as to enable said engine to generate a predetermined amount of compression braking power dependent upon the prevailing engine speed.

8. The method as set forth in claim 7, wherein:
said predetermined time is 15° before said top-dead-center position such that a maximum amount of said compression engine braking power is generated as a function of said engine speed.

9. The method as set forth in claim 7, wherein:
said predetermined time is 150° before said top-dead-center position such that a minimum amount of said compression engine braking power is generated as a function of said engine speed.

10. The method as set forth in claim 1, wherein:
said electronic control module is programmed so as to respectively activate said each one of said at least one exhaust valve disposed within said each one of said plurality of engine cylinders at a predetermined time during said compression stroke of each one of said pistons respectively disposed within said plurality of cylinders wherein said predetermined time includes a time which is intermediate said 15° and 150° time range limitations before said top-dead-center position of said compression stroke and wherein said predetermined time is chosen as a function of engine speed so as to enable said engine to generate a predetermined amount of compression braking power dependent upon the prevailing engine speed.

11. A compression brake system within a combustion engine for achieving a wide range of compression braking power levels, comprising:
at least one exhaust valve disposed within each one of a plurality of cylinders of a combustion engine, wherein each one of said plurality of cylinders has a piston respectively disposed therein; and
an electronic control module connected to each one of said at least one exhaust valve disposed within each one of said plurality of engine cylinders such that said electronic control module can respectively activate said each one of said at least one exhaust valve disposed within said each one of said plurality of engine cylinders at a predetermined time during a compression stroke of each one of said pistons respectively disposed within said plurality of cylinders wherein said time includes a time which is within the range of 15°-150° before the top-dead-center position of said compression stroke so as to enable said engine to generate variable compression braking power levels.

12. The system as set forth in claim 11, wherein:
said electronic control module is programmed so as to respectively activate said each one of said at least one exhaust valve disposed within said each one of said plurality of engine cylinders at a predetermined latest time during said compression stroke of each one of said pistons respectively disposed within said plurality of cylinders wherein said latest time includes said time of 15° before said top-dead-center position of said compression stroke so as to enable said engine to generate a maximum compression braking power level.

13. The system as set forth in claim 11, wherein:
said electronic control module is programmed so as to respectively activate said each one of said at least one exhaust valve disposed within said each one of said plurality of engine cylinders at a predetermined earliest time during said compression stroke of each one of said pistons respectively disposed within said plurality of cylinders wherein said earliest time includes said time of 150° before said top-dead-center position of said compression stroke so as to enable said engine to generate a minimum compression braking power level.

14. The system as set forth in claim 11, wherein:
said electronic control module is programmed so as to respectively activate said each one of said at least one exhaust valve disposed within said each one of said plurality of engine cylinders at a predetermined earliest time during said compression stroke of each one of said pistons respectively disposed within said plurality of cylinders wherein said earliest time includes said time of 100° before said top-dead-center position of said compression stroke so as to enable said engine to generate a minimum compression braking power level and a minimum amount of noise.

15. The system as set forth in claim 11, wherein:
said electronic control module is programmed so as to respectively activate said each one of said at least one exhaust valve disposed within said each one of said plurality of engine cylinders at a predetermined time during said compression stroke of each one of said pistons respectively disposed within said plurality of cylinders wherein said predetermined time includes a time which is an intermediate time between said 15°-150° before said top-dead-center position of said compression stroke so as to enable said engine to generate an intermediate amount of compression braking power and an intermediate amount of noise.

16. The system as set forth in claim 11, wherein:
said electronic control module is programmed so as to respectively activate said each one of said at least one exhaust valve disposed within said each one of said plurality of engine cylinders at a predetermined time during said compression stroke of each one of said pistons respectively disposed within said plurality of cylinders wherein said predetermined time includes a time which is intermediate said 15° and 150° time range limitations before said top-dead-center position of said compression stroke so as to enable said engine to generate an intermediate amount of compression braking power and an intermediate amount of noise.

17. The system as set forth in claim 11, herein:
said electronic control module is programmed so as to respectively activate said each one of said at least one exhaust valve disposed within said each one of said plurality of engine cylinders at a predetermined time during said compression stroke of each one of said pistons respectively disposed within said plurality of cylinders wherein said predetermined time includes a time which is within 15°-150° range of times before said top-dead-center position of said compression stroke and wherein said predetermined time is chosen as a function of engine speed so as to enable said engine to generate a predetermined amount of compression raking power dependent upon prevailing engine speed.

18. The system as set forth in claim 17, wherein:
said predetermined time is 15° before said top-dead-center position such that a maximum amount of said compression engine braking power is generated as a function of said engine speed.

19. The system as set forth in claim 17, wherein:
said predetermined time is 150° before said top-dead-center position such that a minimum amount of said compression engine braking power is generated as a function of said engine speed.

20. The system as set forth in claim 11, wherein:
said electronic control module is programmed so as to respectively activate said each one of said at least one exhaust valve disposed within said each one of said plurality of engine cylinders at a predetermined time during said compression stroke of each one of said pistons respectively disposed within said plurality of cylinders wherein said predetermined time includes a time which is intermediate said 15° and 150° time range limitations before said top-dead-center position of said compression stroke and wherein said predetermined time is chosen as a function of engine speed so as to enable said engine to generate a predetermined amount of compression braking power dependent upon the prevailing engine speed.
